(19) United States
(12) Patent Application Publication
(10) Pub. No.: US 2015/0082689 A1
(43) Pub. Date: Mar. 26, 2015

(54) Small droplet sprayer

(71) Applicants: Jacques C. Bertrand, Gainesville, FL (US); Craig A. Stoops, Orange Park, FL (US)

(72) Inventors: Jacques C. Bertrand, Gainesville, FL (US); Craig A. Stoops, Orange Park, FL (US)

(21) Appl. No.: 14/037,849

(22) Filed: Sep. 26, 2013

(51) Int. Cl. A01M 7/00; B05B 17/06

(52) U.S. Cl. CPC A01M 7/0017; B05B 17/0607
USPC 43/132.1; 239/102.2

(57) ABSTRACT

The inventive subject matter relates to a device and method of its use in producing small droplets of insecticide. The device produces small droplets through ultrasonic frequency sonication. The device is also capable of inducing and electrical charge on the small droplets for better application to flying insects.

### CROSS-REFERENCE TO RELATED APPLICATIONS

This application claims the benefit of provisional application, No. 61/708,184, filed Oct. 1, 2012.

### BACKGROUND OF INVENTION

1. Field of Invention

The inventive subject matter relates to an insecticide sprayer capable of producing droplets less than 5 μm in size. The sprayer utilizes ultrasonic frequency to produce small droplet size.

2. Background Art

Insecticides are typically applied to flying insects by spraying the insecticide with random coating or application based on chance collision with the spray. Current methods of insecticide spraying entail application of a spray with random application of insecticide on the insect as the insect encounters the spray.

Because most spray contains droplets sizes that are relatively large, often as much as 100 μm, the sprayed material settles relatively quickly. This necessitates forming a spray starting fairly high, often using more chemical than is necessary. Production of smaller droplets is typically is accomplished by vaporizing the material by heating it. This approach, however, is problematic in insecticide application due to the often combustible or flammable nature of the chemicals in insecticide formulations.

### SUMMARY OF THE INVENTION

The current invention relates to an insecticide sprayer and method of application of insecticides, capable of producing small size droplets.

### BRIEF DESCRIPTION OF DRAWINGS

FIG. 1. Diagram of the device illustrating major components of sprayer. In the figure, dotted lines indicate flow of material, in the form of droplets, air flow or fluid from the reservoir.

FIG. 2. Diagram of the sprayer device capable sorting droplets by charge. As illustrated in the figure, sorted material is directed out through the sprayer tube. Unsorted material can be directed into a recollection reservoir.

### DETAILED DESCRIPTION OF PREFERRED EMBODIMENTS

Current insecticide spraying equipment are not generally capable of producing fine droplets in the range of 5 μm or less. Small droplets, defined as droplets 5 μm or less, are highly desirable in that small droplets would form a fog-like layer which would accumulate near the ground, where many insects reside. Currently there is only one type of sprayer that is capable of producing droplets less than five microns. This is called a thermo fogger, which uses the latent heat of combustion generated in a chamber that vaporizes the liquid. Unfortunately most of the formulations used in insecticidal spray formulation contain combustible materials. Therefore, use of this approach to produce small droplets may pose a serious safety hazard. This is especially true in areas where combustible materials are present, especially in enclosed or partially enclosed areas. However, use of a thermo fogger to atomize water only results in the formation of droplets in the 27-60 micron range.

It is an advantage to have small droplets for insecticidal spraying. As such there is a need for an apparatus for making less than 5 μm droplets without using heat and capable of forming less than 5 μm droplets cold spray. The problem is even worse for hand held/backpack portable sprayers where the smallest size attainable with water is 15 μm and the average is in the 50 to 100+μm. Interestingly, most hand-held sprayers using water produce 15 μm droplets or greater.

Table 1 shows how the droplet size relates, geometrically, to volume of liquid. The small droplets can have the effect of more effectively carrying and adhering to the target of interest. As shown in Table 1, 422 droplets with a diameter of 2 μm contains the same volume as one 15 μm droplet. Similarly, 3375 drops with a 1 μm diameter would contain the same volume as 1 droplet with a diameter of 15 μm. This attribute ensure more efficient use of material and cost savings.

Additionally, an important attribute of small droplets, especially droplets of less than 5 μm in diameter, is their ability to result in a stable, non-settling fog. A stable non-settling fog with the insecticide formulation would permit many more droplets to be available to contact target insects. Also, the non-settling nature of the fog would allow much greater time for the insects to fly in the presence of the insecticide. Collectively, the characteristics of small, 5 μm droplets increases the efficiency of exposure and delivery of insecticide to the target insects.

TABLE 1

| | | | | number of 2 | # of 1 |
|---|---|---|---|---|---|
| Droplet | | calculated | number of 4 | μm diameter | μm diameter |
| Diam- | droplet | volume = | μm droplets | droplets | droplets |
| eter | radius | 4/3 π r³ | of equal | of equal | of equal |
| (in μm) | (in μm) | (in μm³) | volume | volume | volume |
| 1 | 0.5 | 0.52 | | | 1 |
| 2 | 1 | 4.19 | | 1 | 8 |
| 3 | 1.5 | 14.14 | | 3 | 27 |
| 4 | 2 | 33.51 | 1 | 8 | 64 |
| 5 | 2.5 | 65.45 | 2 | 16 | 125 |
| 10 | 5 | 523.60 | 16 | 125 | 1000 |
| 15 | 7.5 | 1767.15 | 53 | 422 | 3375 |
| 20 | 10 | 4188.79 | 125 | 1000 | 8000 |
| 25 | 12.5 | 8181.23 | 244 | 1953 | 15625 |
| 30 | 15 | 14137.17 | 422 | 3375 | 27000 |
| 35 | 17.5 | 22449.30 | 670 | 5359 | 42875 |
| 40 | 20 | 33510.32 | 1000 | 8000 | 64000 |
| 45 | 22.5 | 47712.94 | 1424 | 11391 | 91125 |
| 50 | 25 | 65449.85 | 1953 | 15625 | 125000 |
| 55 | 27.5 | 87113.75 | 2600 | 20797 | 166375 |
| 60 | 30 | 113097.34 | 3375 | 27000 | 216000 |
| 65 | 32.5 | 143793.31 | 4291 | 34328 | 274625 |
| 70 | 35 | 179594.38 | 5359 | 42875 | 343000 |
| 75 | 37.5 | 220893.23 | 6592 | 52734 | 421875 |
| 80 | 40 | 268082.57 | 8000 | 64000 | 512000 |
| 85 | 42.5 | 321555.10 | 9596 | 76766 | 614125 |
| 90 | 45 | 381703.51 | 11391 | 91125 | 729000 |
| 95 | 47.5 | 448920.50 | 13396 | 107172 | 857375 |
| 100 | 50 | 523598.78 | 15625 | 125000 | 1000000 |

In addition to use of small, 5 μm droplets, application of charge to the droplets would be advantageous for further efficiency of application. Where application is intended for flying insects, the charge of the droplets should typically be negatively charged, since insects are believed to induce a positive charge on their bodies during flight. The negatively charged droplets would be attracted to the insect thus making the amount of charged droplets coming into contact with the insect is much greater.

### EXAMPLE 1

### Small Droplet Atomizer

In a preferred embodiment, the inventive device is capable of producing and expelling droplet sizes of liquids, defined as 5 μm or smaller. The device comprises a reservoir (1), connected, via a connection tube (3) capable of permitting fluid to pass to a transducer drum (5). The transducer drum contains one or more transducers (9) that are electrically connected to a suitable power source (17). The power source (17) is capable of generating electrical oscillations in the ultrasonic frequency range. Ultrasonic frequency range is defined as a frequency of oscillation above 19 kHz.

As an example, in one embodiment, the ultrasonic frequency is approximately 0.8 MHz to approximately 1.7 MHz. Power switching with the power switching transistor can be arranged as Colpitts oscillator. In a preferred embodiment, the frequency is 1.65 MHz.

Any type of transducer can be utilized, including magnetostrictive or piezo-electric transducers. In a preferred embodiment, piezo-electric transducers are utilized. In one embodiment, the frequency is adjustable to produce the desired droplet size.

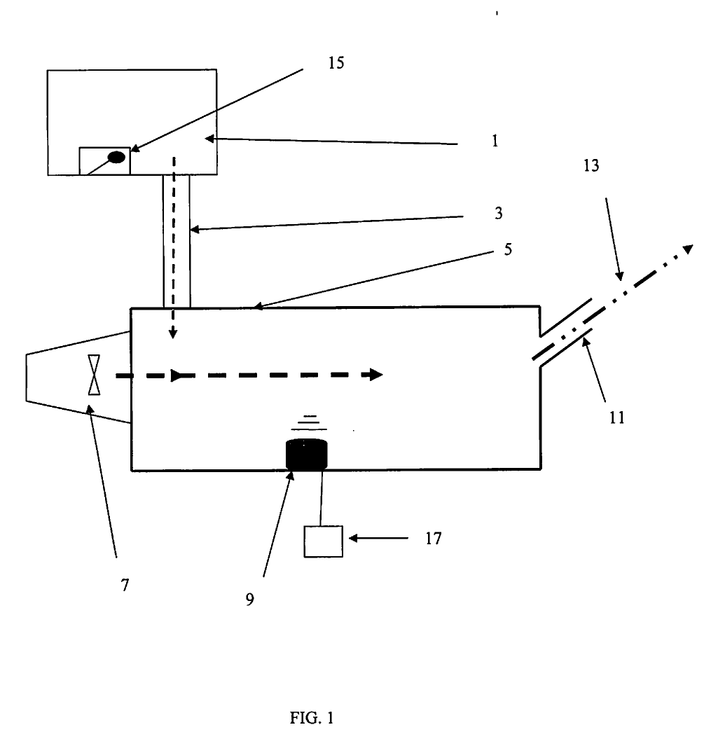

The inventive device can be configured in a number of ways. FIG. 1 illustrates an example of one embodied configuration of the device. As shown in FIG. 1, insecticide is supplied to a transducer drum (5) from a reservoir (1), via a connection (3) between the reservoir (1) and transducer drum (5), at one of two ends of the transducer drum (5) is a fan (7), which is capable of blowing droplets to the opposite end of the transducer drum (5) and out of the drum via a sprayer tube (11). In another embodiment, the reservoir (1) also comprises a fluid level indicator (15).

In a preferred embodiment, fluid in the reservoir (1) flows through the connection tube (3) to the transducer drum (5). In the transducer drum (5), fluid is subjected to sonication via one or more ultrasonic transducers (9), which vibrate at ultrasonic frequency. Any type of transducer can be utilized, including magnetostrictive or piezo-electric transducers. FIG. 1 illustrates the device with a single transducer. Small droplets, of 5 μm or less, are then formed, which are expelled (13) through the sprayer tube (11).

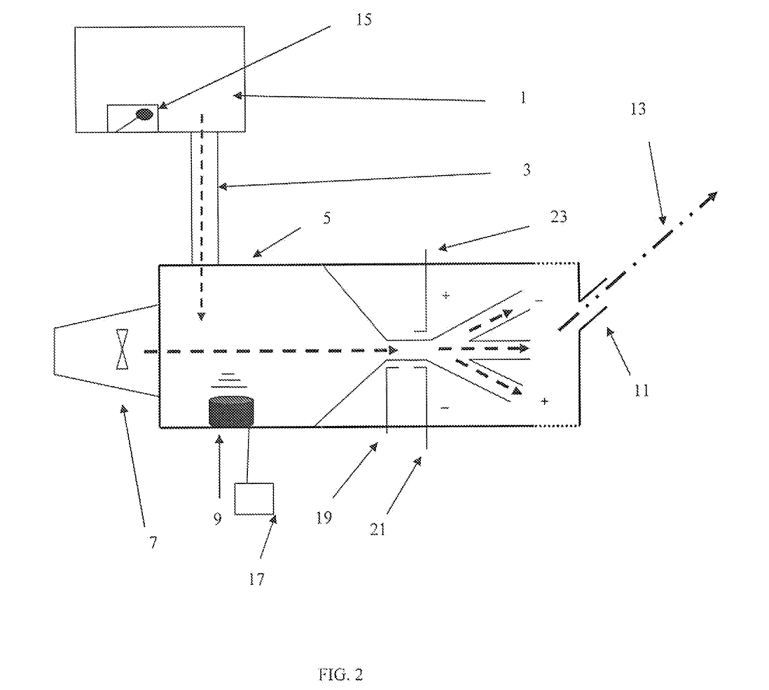

Table 2 illustrates the results of a study using ultrasonic transducer to produce droplets of different fluid materials. In this study, various chemical formulations are emitted from a commercially available ultrasonic humidifier (Hunter® model 31004). The humidifier's transducer oscillates at an ultrasonic frequency of 1.65 MHz. The transducer is used here as a prototype that would be incorporated into the inventive device of FIG. 1 or FIG. 2. Table 2 shows the range of droplets emitted. DV_{0.1} represents 10% of the droplets emitted; DV_{0.5} represents the median diameter of the droplets; while DV_{0.9} represents the 90% of the droplets size.

TABLE 2

| | Composition of | # of droplets | | DV_{0.5} | |
|---|---|---|---|---|---|
| | droplet | measured | DV_{0.1}² | (volume¹) | DV_{0.9}³ |
| 1 | Water | 2274 | 2.94 | 4.76 | 8.53 |
| 2 | Water | 1904 | 3.16 | 5.15 | 8.78 |
| 3 | 75% diesel oil; | 3547 | 2.28 | 3.92 | 7.92 |
| | 23.75% ethyl | | | | |
| | acetate; 5% | | | | |
| | permethrin | | | | |
| 4 | 50% BVA 13 | 891 | 2.66 | 5.32 | 7.65 |
| | oil; 50% ethyl | | | | |
| | acetate | | | | |
| 5 | 47.5% BVA 13 | 1672 | 2.2 | 4.72 | 9.56 |
| | oil; 47.5% | | | | |
| | ethyl acetate; | | | | |
| | 5% permethrin | | | | |
| 6 | 10% Aqua | 1947 | 1.33 | 5.74 | 17.26 |
| | Reslin ® | | | | |
| | Concentrate; | | | | |
| | 90% water | | | | |
| 7 | 10% Aqua | 1466 | 1.5 | 6.78 | 14.57 |
| | Kontrol ® | | | | |
| | Concentrate; | | | | |
| | 90% water | | | | |
| 8 | 10% Aqualuer | 593 | 1.18 | 5.07 | 8.54 |
| | 20-20 ® | | | | |
| | Concentrate; | | | | |
| | 90% water | | | | |

¹Median of diameter
²Diameter of 10% of droplets
³Diameter of 90% of droplets

As illustrated in Table 2, the humidifier emits droplets within a range of 1.5 μm to 17.26 μm, depending on the source material. For example, the ultrasonic humidifier was able to produce droplets of 47.5% BVA 13 oil (BVA, Inc, Wixom, Mich.) with 47.5% ethyl acetate and 5% permethrin (3-Phenoxybenzyl (1RS)-cis,trans-3-(2,2-dichlorovinyl)-2,2-dimethylcyclopropanecarboxylate) with an average diameter (i.e., DV0.5) of 4.72 μm, with 10% of the droplets as small as 2.2 μm. Similarly, 10% Aqua-Kontrol® Concentrate (Masterline®, Univar, Austin, Tex.) and 90% water yielded 10% of the droplets with a diameter of 1.5 μm with an average diameter of 6.78 μm.

In another study, droplets were created by a prototype mister, fabricated by Humidifirst™, Inc. (Boynton Beach, Fla.). The prototype mister comprised a solenoid valve control of water (i.e., fluid) flow into the humidifier; a float switch to control water level; and a float switch to provide for low water shutdown; a blower fan; and 4 piezoelecrtric crystals (i.e., transducers). Droplet size was monitored by a Phase Doppler Particle Analyzer (PDPA) (TSI, Inc, Shoreview, Minn.). The results of the study are illustrated in Table 3. As illustrate in Table 3, the median volume in this study was 7.13 μm to 7.35 μm, with approximately 10% of the droplets 3.75 μm to 3.82 μm.

TABLE 3

| | Droplet diameter (μm)¹ | | | | |
|---|---|---|---|---|---|
| | | | DV.5 | | |
| | | | (volume | | Mean |
| | | | median | | Velocity, |
| Spray Liquid | Rep | DV.1 | diameter) | DV.9 | meters/sec |
| Water | 1 | 3.82 | 7.35 | 14.60 | 1.27 |
| Water | 2 | 3.77 | 7.13 | 14.51 | 1.45 |
| Water | 3 | 3.75 | 7.19 | 16.19 | 1.44 |

¹DV.1 = 10% of spray volume is contained in droplets of this volume or smaller; DV.5 = 50% of spray volume is contained in droplets of this volume or smaller; DV.9 = 90% of spray volume is contained in droplets of this volume or smaller.

### EXAMPLE 2

### Charged Droplet Atomizer

Flying insects generate an electrical charge as they move through the air. As such, negatively charged particles would be attracted to those regions of the flying insect that have imparted a positive charge.

Procedures and devices have been described capable of generation of charged droplets. In general, this is conducted by exposing of droplets to a suitable electrical field (Ahn, et al., Biomicrofluidics 3, 044102 (2009); Pilat and Lukas, Air and Waste Manage. Assoc. 54: 3-7 (2004)). Exposing fluids to an electric field is also utilized in electrostatic spray devices and methods (Stark, et al., U.S. Patent Application 2010/0155496 (Jun. 24, 2010)); Imai, et al., U.S. Patent Application 2012/0153055 (Jun. 21, 2012)).

In one embodiment of the current device, illustrated in FIG. 2, fluid from the reservoir (1) flows through the connection tube (3) and is discharged into the transducer drum (5). In the transducer drum (5), the fluid is subjected to ultrasonic frequency oscillations via one or more ultrasonic transducers (9). The transducer (s) is electrically connected to a suitable power source (17) that is capable of generating electrical oscillations of ultrasonic frequency, defined as above 19 kHz. As an example, in one embodiment, the ultrasonic frequency is approximately 0.8 MHz to approximately 1.7 MHz. Power switching, with the power switching transistor, can be arranged as Colpitts oscillator. In a preferred embodiment, oscillation at 1.65 MHz is utilized.

The ensuing small (5 μm) droplets can then be imparted with a charge. Any number of methods for imparting charge on the droplets is contemplated. However, as an example, illustrated in FIG. 2, after creation of the small 5 μm droplets by the transducer, the droplets are forced by the fan (7) past an electrical field created by electrodes (19) imparting an electrical charge to the droplets. The charged droplets are then directed into the sprayer tube (11) and discharged (13) from the device. Unsorted material can be directed into a recollection reservoir or other collection means for recycling or disposal.

In another embodiment, charge droplets can be separated based on charge. Any number of separation methods are contemplated. However, as an example, also illustrated in FIG. 2, as the droplets move past oppositely charged electrodes (21 and 23). The deflected droplets are then collected, based on deflection and discharged (13) via the sprayer tube (11).

### EXAMPLE 3

### Method of Applying Insecticide by Electrostatic Droplets

In applying insecticide sprays to flying insects, current methods typically entail spraying in the vicinity of the insects and the insects encountering the spray by random collisions with the droplets. Furthermore, since insecticide droplets are typically relatively large, often over 50 μm in diameter, the droplets tend to settle relatively quickly. The rapid settling of insecticide necessitates application of large amounts of material at a height to enable adequate collisions of the insects with the insecticide droplets. The result is that significant amounts of insecticide, which is wasted and not actually encountered by the insect, in order to afford efficacy of the spraying with adequate coverage of area.

In one embodiment, small, 5 μm diameter droplets, or less, are created with the device described in Example 1. Application of insecticide is then applied to the desired area creating a slow settling fog, since the small droplets will tend to settle to the ground slowly and linger longer in the air. The longer lingering increases the likelihood of collision with the droplets by flying insects. Use of the method would result in the need for less insecticide, with greater insecticide effectiveness.

In an additional embodiment, an electrical charge can be imparted on the small, i.e., 5 μm or less diameter, droplets, as in Example 2. The charged droplets would linger longer in the air, as a fog, than larger droplets increasing collision of droplets by flying insects. Additionally, the charged droplets will be attracted to the inherent electrical charge on the insects. Use of charged droplets would result in the need for even less insecticide material than if only small droplets were utilized.

Having described the invention, one of skill in the art will appreciate in the appended claims that many modifications and variations of the present invention are possible in light of the above teachings. It is therefore, to be understood that, within the scope of the appended claims, the invention may be practiced otherwise than as specifically described.

What is claimed is:

1. A small droplet insecticide sprayer comprising a fluid reservoir connected to a transducer drum, wherein insecticide is delivered from said fluid reservoir to said transducer drum containing a fan on one end, whereby the fan is positioned to force air along the length of the transducer drum, and wherein insecticide is subjected to sonication by one or more transducers, which are electrically connected to a power source capable of generating electrical oscillations of ultrasonic frequency, creating small droplets of 5 μm or less, and whereby the small droplets are ultimately expelled from the transducer drum via a sprayer tube at the opposite end of the transducer drum from said fan.

2. The insecticide sprayer of claim 1, whereby the transducer is a magnetostrictive or piezoelectric.

3. The insecticide sprayer of claim 1, whereby the power source and transducer is capable of generating electrical oscillations of 0.8 MHz to 1.7 MHz.

4. The insecticide sprayer of claim 1, whereby the power source and transducer is capable of generating electrical oscillations of above 1.7 MHz.

5. The insecticide sprayer of claim 1, whereby the power source comprises a power switching transistor arranged as a Colpitts oscillator.

6. The insecticide sprayer of claim 1, whereby the reservoir comprises a fluid level indicator.

7. The insecticide sprayer of claim 1, whereby the transducer drum comprises a means for inducing an electric charge on the droplets.

8. The insecticide sprayer of claim 1, whereby the droplets can be sorted based on charge prior to being expelled from the transducer drum via the sprayer tube.

9. A method of applying insecticide to flying insects comprising producing droplets with diameters of 1.5 to 17 μm by the device of claim 1 and exposing flying insects to said droplets.

10. The method of claim 9, whereby an electrical charge is induced on the small droplets, whereby the charged droplets are attracted to and adhere to the insect.

11. The method of claim 9, whereby a negative charge is induced on the small droplets, which are attracted to the positive charge on the insect.

12. A method of producing droplets using the device of claim 1.

13. The method of claim 12, wherein said transducer is a magnetostrictive or piezoelectric.

14. The method of claim 12, wherein the power source and transducer is capable of generating electrical oscillations above 0.8 MHz.

15. The method of claim 12, wherein the power source and transducer is capable of generating electrical oscillations of 0.8 MHz to 1.7 MHz.

16. The method of claim 12, wherein the power source comprises a power switching transistor arranged as a Colpitts oscillator.

17. The method of claim 12, wherein the reservoir comprises a fluid level indicator.

18. The method of claim 12, wherein the transducer drum comprises a means for inducing an electric charge on the droplets.

19. The method of claim 12, wherein the droplets can be sorted based on charge prior to being expelled from the transducer drum via the sprayer tube.
